(19) United States
(12) Patent Application Publication
(10) Pub. No.: US 2026/0119657 A1
(43) Pub. Date: Apr. 30, 2026

(54) CENTRALIZED ATTACK SURFACE VISUALIZATION FOR DISTRIBUTED DATA STORAGE

(71) Applicant: RAY RESEARCH, LTD., Ramat Gan (IL)

(72) Inventors: Ariel ZAMIR, Kibbutz Ramot Menashe (IL); Eric WOLF, Tel Aviv (IL); Dekel LEVKOVITCH, Savyon (IL)

(21) Appl. No.: 19/373,652

(22) Filed: Oct. 29, 2025

Related U.S. Application Data
(60) Provisional application No. 63/713,796, filed on Oct. 30, 2024.

(51) Int. Cl. G06F 21/56

(52) U.S. Cl. CPC G06F 21/56

(57) ABSTRACT

A computer-implemented method, comprising: operationally connecting to a distributed computer system comprising a distributed storage, by interfacing with one or more data sources within the computer system; obtaining an inventory of all data objects in the distributed computer system; collecting metadata regarding each of the data objects; based on the metadata, generating, with respect to each of the data objects, a prediction which indicate a likelihood that the data object will be accessed by a user within a future predefined period of time; and generating and displaying a centralized graphical visualization of the predictions with respect to all of the data objects in the distributed computer system.

### CROSS-REFERENCE TO RELATED APPLICATIONS

This application claims priority from U.S. Application Ser. No. 63/713,796, filed Oct. 30, 2025, entitled “CENTRALIZED ATTACK SURFACE VISUALIZATION FOR DISTRIBUTED DATA STORAGE,” the contents of which are hereby incorporated herein in their entirety by reference.

### FIELD OF THE INVENTION

This invention relates to the field of network and computer security, and specifically, mitigation of exposure to malicious software attacks.

Intrusion by malicious software or malware that steals, erases, or modifies system resources, data, and private information is a concern for corporations, government agencies, and other enterprises that store confidential or irreplaceable data. Malware cam come in the form of computer viruses, worms, trojan horses, spyware, keystroke loggers, adware, rootkits, and ransomware.

File-modifying malware include ransomware which aims to block access to system applications and files by encrypting data to make it inaccessible, typically until a ransom is paid. Another type of malware in this category is wipers, which erase (or wipe) data and files, making recovery difficult or impossible. A third type seeks to steal or exfiltrate data from a computer system.

To counter these threats, enterprises and individuals use a range of security applications and services which scan computer systems for signatures of certain malware, in order to quarantine or disable the malware. However, these security applications are reactive in nature, and can fail to detect sophisticated security intrusions and take remedial actions before the malware is able to cause significant and often irreparable damage.

Many organizations use distributed storage, which is a method of storing data across multiple physical or virtual locations. Rather than centralizing data in one place, it is divided into smaller parts and stored on various devices, combining proprietary data centers, often located in various geographic locations, and public cloud and similar platforms. These storage devices are in turn interconnected through a network, such as the internet or a local area network (LAN), which provides access to the stored data.

Distributed storage schemes offer advantages such as scalability, greater resilience and fault tolerance, reduced costs, improved performance, and ability to comply with various privacy and data management regulatory regimes.

However, distributed storage presents security and data protection challenges, specifically in the configuration and management of security controls across multiple locations and platforms. This problem is exacerbated due to the dynamic behavior of distributed storage systems, which are characterized by nodes frequently leaving and joining the system.

The foregoing examples of the related art and limitations related therewith are intended to be illustrative and not exclusive. Other limitations of the related art will become apparent to those of skill in the art upon a reading of the specification and a study of the figures.

### SUMMARY OF THE INVENTION

The following embodiments and aspects thereof are described and illustrated in conjunction with systems, tools and methods which are meant to be exemplary and illustrative, not limiting in scope.

There is provided, in an embodiment, a computer-implemented method, comprising: operationally connecting to a distributed computer system comprising a distributed storage, by interfacing with one or more data sources within the computer system; obtaining an inventory of all data objects in the distributed computer system; collecting metadata regarding each of the data objects; based on the metadata, generating, with respect to each of the data objects, a prediction which indicate a likelihood that the data object will be accessed by a user within a future predefined period of time; and generating and displaying a centralized graphical visualization of the predictions with respect to all of the data objects in the distributed computer system.

There is also provided, in an embodiment, a system comprising at least one processor; and a non-transitory computer-readable storage medium having stored thereon program instructions, the program instructions executable by the at least one processor to: operationally connect to a distributed computer system comprising a distributed storage, by interfacing with one or more data sources within the computer system, obtain an inventory of all data objects in the distributed computer system, collect metadata regarding each of the data objects, based on the metadata, generate, with respect to each of the data objects, a prediction which indicate a likelihood that the data object will be accessed by a user within a future predefined period of time, and generate and display a centralized graphical visualization of the predictions with respect to all of the data objects in the distributed computer system.

There is further provided, in an embodiment, a computer program product comprising a non-transitory computer-readable storage medium having program instructions embodied therewith, the program instructions executable by a computer system to: operationally connect to a distributed computer system comprising a distributed storage, by interfacing with one or more data sources within the computer system; obtain an inventory of all data objects in the distributed computer system; collect metadata regarding each of the data objects; based on the metadata, generate, with respect to each of the data objects, a prediction which indicate a likelihood that the data object will be accessed by a user within a future predefined period of time; and generate and display a centralized graphical visualization of the predictions with respect to all of the data objects in the distributed computer system.

In some embodiments, the predictions are generated by applying a trained prediction model to the metadata regarding each of the identified data objects, to obtain the predictions.

In some embodiments, the prediction model is trained on a training dataset comprising a plurality of feature sets, each representing the metadata collected over a defined period of time regarding a respective one of the data objects, wherein each of the feature sets is labeled with a label indicating user access instances with respect to the respective data object which occurred subsequently to the defined period of time.

In some embodiments, the prediction assigns to each of the data objects one the following class labels (i) active, indicating that the data object is likely to be accessed by a user within the future predefined period of time, or (ii) inactive, indicating that the data object is unlikely to be accessed by a user within the future predefined period of time.

In some embodiments, each of the class labels is associated with a probability score.

In some embodiments, the metadata comprises, with respect to each of the data objects, historical access and usage data comprising one or more of the following: times of access instances; count, frequency and recency of access instances; identity of accessing users; and types of access instances.

In some embodiments, the metadata further includes, with respect to each respective the data object, the historical access and usage data with respect to other the data objects sharing the same or a similar name to the respective data object.

In addition to the exemplary aspects and embodiments described above, further aspects and embodiments will become apparent by reference to the figures and by study of the following detailed description.

### BRIEF DESCRIPTION OF THE FIGURES

The present invention will be understood and appreciated more comprehensively from the following detailed description taken in conjunction with the appended drawings in which:

FIG. 1A depicts an exemplary distributed computer environment.

FIG. 1B illustrates an exemplary distributed storage model which may be used in conjunction with a distributed computer environment.

FIG. 2A is a graph that shows the gap between file permissions granted to users in an enterprise, and the actual usage profile of the file by the same users.

FIG. 2B depicts a similar case within an enterprise which implements active continuous mitigation of the exposure of a computer system or environment to malware attacks, by limiting and reducing the potential attack surface.

FIG. 3A is a block diagram of an exemplary system for realizing the present technique for dynamic centralized graphical visualization of a potential attack surface in a distributed computer system or environment.

FIG. 3B depicts an exemplary centralized graphical visualization of activity status prediction results with respect to data objects within a distributed computer environment comprising distributed storage.

FIG. 4A illustrates the functional steps in a method for generating and displaying a centralized graphical visualization of a potential attack surface in a distributed computer system or environment, based, at least in part, on categorizing each of the data objects within the distributed computer system or environment according to its predicted activity status.

FIG. 4B illustrates the functional steps in a method for training and inferencing a prediction model configured to output a classification which indicates a predicted activity status with respect to each of data object in a distributed computer environment.

FIG. 5A provides an overview of a pipeline for training and inferencing a prediction model of the present technique.

FIG. 5B provides an overview of a pipeline for periodic inferencing and updating a prediction model of the present technique.

### DETAILED DESCRIPTION

Disclosed herein is a technique, embodied in a system, method, and computer program product, for real-time dynamic centralized graphical visualization of a potential attack surface in a distributed computer system or environment. In some embodiments, the attack surface of a computer system represents its exposure to malware and other similar malicious attacks.

In some embodiments, the present technique provides for real-time dynamic centralized graphical visualization of a potential attack surface of a distributed computer system or environment, wherein the attack surface may be defined as the potential exposure of the computer system or environment to malware attacks which seek to modify, erase, and/or exfiltrate files and data, such as ransomware attacks, swiper attacks, and the like.

In some embodiments, the present technique provides for real-time centralized graphical visualization of a potential attack surface in a distributed computer system or environment, based, at least in part, on categorizing each of the data objects within the distributed computer system or environment according to its predicted activity status. In some embodiments, categorizing each of the data objects within the distributed computer system or environment according to its predicted activity status is based on a predicted activity status with respect to each of the data objects in the distributed computer environment. In some embodiments, a predicted activity status with respect to each of the data objects in the distributed computer environment indicates the likelihood that any such data object will be used and/or accessed by a user of the computer system or environment within a future predefined period of time, such as the next hour, day 7 days, 14 days, 30 days, or any other desired or suitable period of time.

In some embodiments, the present technique provides for real-time dynamic centralized graphical visualization of a potential attack surface in a distributed computer system or environment, based, at least in part, on categorizing each of the data objects within the distributed computer system or environment according to its predicted activity status. In some embodiments, the predicted activity status of a data object may be categorized into one of the following exemplary categories:
Active Data Object: These are ‘live’ data objects that are likely to be used and/or accessed on a read/write/modify basis by at least one system user within the future predefined period of time.
Read-Only Data Object: These are data objects that are likely to be used and/or accessed on a read-only basis by at least one system user within the future predefined period of time.
Inactive Data Object: these are dormant or ‘cold’ data objects, that are unlikely to be used and/or accessed by any system user within the future predefined period of time.
Routine Maintenance: The data object likely to be used and/or accessed for periodic or routine system maintenance or for similar purposes within the future predefined period of time.

In some embodiments, categorizing all data objects within the distributed computer system or environment according to these or similar categories allows system administrators to apply specific security configurations to each data object, based on its predicted activity category. Thus, for example, data objects predicted as likely to be used and/or accessed on a read/write basis by a user within the future predefined period of time, may be designated as ‘active’ data objects, and made available for access by their users in the computer environment over the future predefined period of time. In some cases, such active data objects may be stored in a dedicate storage cache, that is secure, scanned for malware, and virtually air-gapped from the rest of the data. In some embodiments, such data objects may be made available for access by users in the computer environment using their standard login or permission protocols in use by the computer environment.

Conversely, data objects categorized as unlikely to be used and/or accessed on a read/write basis by a user in the computer environment within the future predefined period of time, may be designated as ‘inactive’ data objects. Such data objects designated may be subject to enhanced security measures or protocols. For example, in some cases, a data object designated as inactive may be subject to modified access protocols, which may require, for example, multi-factor authentication (MFA) to access the data object, or to have read and/or write privileges with respect to the data object. In some cases, a data object designated inactive may be designated as “read only,” thereby eliminating write access to these data objects, which reduces the risk that these data objects will be encrypted in a ransomware attack. In other cases, a data object designated inactive may be subject to modified read and/or write permissions that are limited to only those users which have active authorization to use such data object, and have in fact accessed such data object within a recent specified period.

Accordingly, in some embodiments, the present technique provides for real-time dynamic centralized graphical visualization of a potential attack surface in a distributed computer system or environment, based, at least in part, on categorizing each of the data objects within the distributed computer system or environment according to its predicted activity status. In some embodiments, categorizing each of the data objects within the distributed computer system or environment according to its predicted activity status is based on a predicted activity status with respect to each of the data objects in the distributed computer environment. In some embodiments, a predicted activity status indicates the likelihood that any data object will be used and/or accessed by a user of the computer system or environment within a future predefined period of time.

For purposes of this disclosure, the terms “data object,” “data item,” and/or “data asset” refer interchangeably broadly to any constituent data units of a computer environment, including any files, file directories, user directories, databases, data storage or repositories, computer sub-systems, external computer systems, storage devices, software programs or applications, websites, users, groups, end-devices, servers, network nodes, storage nodes, and the like.

For purposes of this disclosure, the term “metadata” with reference to a data object, refers broadly to any attributes, information, data points and statistics associated with each data object in a computer system, including, but not limited to, system metadata and data object access and usage data.

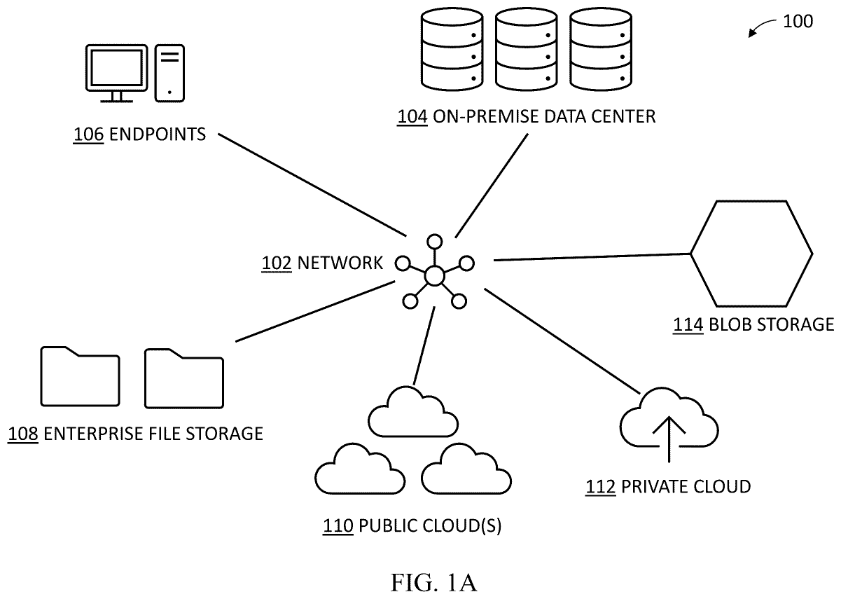

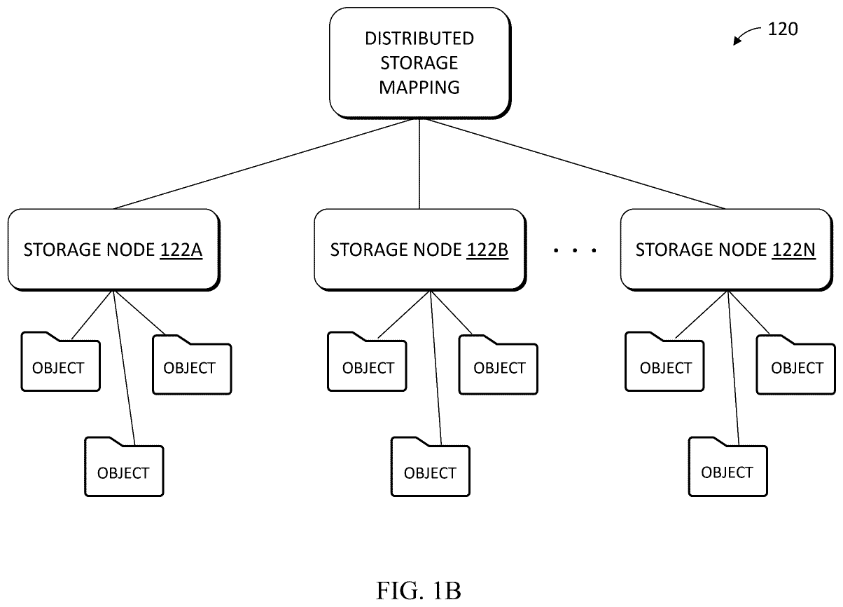

FIG. 1A depicts an exemplary computer system 100, in which the present technique for active continuous mitigation of the exposure of a computer system or environment to malware attacks, by limiting and reducing the potential attack surface, may be realized.

In some embodiments, computer system 100 may be any private, enterprise, governmental agency, healthcare facility, or similar computer system or environment. In some embodiments, computer system 100 comprises such elements as:
A network 102 which interconnects the various nodes of distributed computer system 100 and provides access to the stored data therein. Network 102 may comprise one or more interconnected private and public networks, including, but not limited to, a local area network (LAN), a virtual network, such as Microsoft Azure Virtual Network or similar, and/or the Internet.

### an On-premise Data Center 104.

One or more endpoints 106, such as workstations, laptops, and mobile devices.
Enterprise file storage 108.
One or more public clouds 110.
A private cloud 112.
A blob storage 114.

However, in other cases, computer system 100 may comprise fewer, additional, and/or other different components and elements.

In some embodiments, distributed computer system 100 may comprise a distributed storage model, such as exemplary distributed storage model 120 illustrated in FIG. 1B. Distributed storage 120 may be organized as an arbitrary plurality of storage nodes 122A-122N accessible to users of distributed computer system 100 according to a configurable data access plan. Each storage node 122 may in turn be configured to store an arbitrary plurality of data objects.

In some embodiments, computer system 100 is a distributed or decentralized computer environment, where data objects are stored or reside in more than one location or node, including proprietary on-premise and remote data centers, private cloud, and/or public cloud and similar platforms. In some cases, distributed storage 120 may store replicas of data objects within two or more storage nodes 122A-122N. However, each replica need not correspond to an exact copy of the data object, and thus each replica may be designated as a separate data object. In some embodiments, a data object may be divided into a number of portions according to an encoding scheme, such that the object data may be recreated from all or some of the generated portions, wherein the generated data object portions may be stored respectively in one or more storage nodes 122A-122N.

In some embodiments, distributed storage 120 may generate and store a mapping between data objects and storage nodes 122A-122N, which identifies a location of each data object within the plurality of storage nodes 122A-122N.

In some embodiments, the present technique provides for real-time dynamic centralized graphical visualization of a potential attack surface in a distributed computer system or environment, based, at least in part, on categorizing each of the data objects within the distributed computer system or environment according to its predicted activity status. In some embodiments, categorizing each of the data objects within the distributed computer system or environment according to its predicted activity status is based on a predicted activity status with respect to each of the data objects in the distributed computer environment. In some embodiments, predicted activity status with respect to each of the data objects in the distributed computer environment is generated by a prediction model configured to output a classification which indicates a predicted activity status with respect to each of the data objects in distributed computer system 100. In some embodiments, predicted activity status with respect to each of the data objects in distributed computer system 100 indicates the likelihood that such data object will be used and/or accessed by a user within a future predefined period of time, such as the next hour, day 7 days, 14 days, 30 days, or any other desired or suitable period of time.

In some embodiments, the present technique is based on machine learning prediction model configured to classify data objects in a target computer system, such as computer system 100, based on the likelihood that each data object will be used and/or accessed of the system within a future predefined period of time, e.g., within the next hour, day, 7 days, 14 days, 30 days, or any other desired or suitable period of time. In some embodiments, the trained prediction model may be periodically or recurringly refined or re-trained using the updated inventory and usage information collected periodically or recurringly with respect to the computer environment.

In some embodiments, the present technique provides for a data object discovery stage, wherein a forensic scan of a target computer system is performed, to discover, locate, catalog, and create an inventory and mapping of all data objects in the target computer system. In some embodiments, the data object discovery stage may be performed by a client application that is native to the target computer system. However, in other cases, the data object discovery stage may be performed by an external computer system (e.g., a data discovery system) which may operationally connect to the target computer system via a public or private data network, and deploy a client application to perform the data discovery process. In some embodiments, the data object discovery stage may be repeated periodically or recurringly, e.g., hourly, daily, weekly, bi-weekly, monthly, or according to any desired recurring schedule.

In some embodiments, the present technique then provides for collecting information with respect to historic and current usage of data objects in computer environment, including, but not limited to, data object type, location, owner, author, main contributor(s), data object access and modification permissions, object access instances history (including, e.g., count, frequency, recency, and time of access instances, accessing user, type of access instances—read/write/modify), and events associated with data access instances. In some embodiments, the present technique may be configured to collect the information with respect to usage of data objects in the created inventory periodically or recurringly, for example, hourly, daily, weekly, bi-weekly, etc.

In some embodiments, the collected information may be used to train a dedicated machine learning prediction model, to output a classification which indicates, with respect to each of the data objects in the computer environment, the likelihood that such data object will be used and/or accessed within a future predefined period of time, e.g., within the next hour, day, 7 days, 14 days, 30 days, or any other desired or suitable period of time. In some embodiments, this prediction indicates the need to keep a given data object readily accessible to system users, i.e., whether a particular data object should remain readily accessible using ordinary access procedures, or for example, can it be made subject to enhanced access controls.

In some embodiments, the trained prediction model may be periodically or recurringly refined or re-trained using updated data object inventory and usage information collected periodically or recurringly with respect to the computer environment.

In some embodiments, the prediction model is trained to output a binary classification (i.e., 0/1, or yes/no) which indicates, with respect to each of the data objects in the computer environment, whether or not it is likely to be used and/or accessed within the future predefined period of time.

In other cases, the prediction model is trained to output a multi-class classification, which assigns one of a set of three or more predetermined class labels to each data object. In one example, such set of classes may comprise, but is not limited to, the following classes:
Active Data Object: These are ‘live’ data objects that are likely to be used and/or accessed on a read/write/modify basis by at least one system user within the future predefined period of time.
Read-Only Data Object: These are data objects that are likely to be used and/or accessed on a read-only basis by at least one system user within the future predefined period of time.
Inactive Data Object: these are dormant or ‘cold’ data objects, that are unlikely to be used and/or accessed by any system user within the future predefined period of time.
Routine Maintenance: The data object likely to be used and/or accessed for periodic or routine system maintenance or for similar purposes within the future predefined period of time In a typical enterprise computer system or environment, the trained prediction model is expected to classify between 2-4% of the total data objects in the computer environment as “active” i.e., data objects which are likely to be used and/or accessed on a read/write/modify, read-only or for maintenance purposes within the future predefined period of time. The trained prediction model is thus expected to classify the balance of the data objects in the computer environment (between 96-98% of the total) as “inactive,” i.e., as data objects which are unlikely to be used and/or accessed on a read/write/modify basis within the future predefined period of time.

In the case that the prediction model is trained to output a binary classification (i.e., 0/1, or yes/no), the balance of the data objects (between 96-98% of the total) will be classified as “inactive,” i.e., as data objects which are unlikely to be used and/or accessed on a read/write/modify basis within the future predefined period of time.

In the case that the prediction model is trained to output a multi-class classification as per the example given immediately above, the balance of the data objects in the computer environment, i.e., between 96-98% of the total, will be classified as one of, as the case may be: data object likely to be used and/or accessed on a read-only basis; data object unlikely to be used or accessed; and/or data object likely to be used and/or accessed for periodic system maintenance or similar purposes only.

In some embodiments, the present technique may then provide for caching those data objects classified as “active,” i.e., likely to be used and/or accessed on a read/write/modify basis within the future predefined period of time, in a dedicate storage cache, that is secure, scanned for malware, and virtually air-gapped from the rest of the data. In some embodiments, the active data objects are made available for access over the future predefined period of time. In some embodiments, such data objects are made available for access using the standard login or permission protocols in use by the computer environment.

In some embodiments, the secure cache may be an immutable storage which cannot be altered, deleted, or modified, to ensure data integrity and protection against threats like ransomware, accidental deletions, or malicious tampering. In some embodiments, the secure cache provides for tamper-proof storage which protects against unauthorized changes, including those by insiders or external threats like ransomware. In some embodiments, the secure cache may employ one or more of the following specific technologies and processes to ensure data integrity and protection:
Air-Gapped Storage: Data may be stored offline or in isolated environments to further protect against network-based attacks.
WORM Storage: Data may be stored in a WORM (write once, read many) format that ensures data can only be written once and cannot be altered or deleted after that initial write.
Data Object Lock: In cloud storage (e.g., AWS S3, Azure Blob Storage), an “object lock” feature can enforce immutability by preventing changes or deletions to objects for a set period.
Encryption: Data may be encrypted to enhance security.

In some embodiments, the secure cache may be based, at least in part, on hardware-based solutions, such as tape storage with WORM capabilities or dedicated immutable cache appliances from vendors such as NetApp or Dell EMC. In some cases, the secure cache may be based, at least in part, on features and technologies offered by cloud provides, such as AWS S3 Object Lock, Azure Blob Storage Immutable Storage, Google Cloud Storage Lock, and the like. In other cases, the secure cache may be based, at least in part, on storage software solution, such as Veeam, Rubrik, Cohesity, Commvault, and the like.

The secure cache ensures that, in the event of a ransomware attack, critical active data objects remain accessible, thereby maintaining business continuity. Because the secure cache represents a small fraction of the total volume of data (e.g., 2-4%), it significantly reduces the resources required for data storage and backup, compared to traditional solutions. The relatively small size of the cache further allows measures that are difficult to implement when dealing with larger volumes of data—rigorous scanning against malware, reduced penetrability and attack surface, machine learning-based encryption testing, versioning in case of encryption suspicion, as well as frequent restore tests. The restore tests can be used to ensure the integrity and non-encrypted status of the cached data, as well as enable quick and efficient recovery exercises that are not feasible with larger data volumes typically associated with conventional backup systems.

In some embodiments, the present technique further provides for designating all other data objects, i.e., those classified as unlikely to be used and/or accessed on a read/write/modify basis within the future predefined period of time, as “inactive” data objects (representing between 96-98% of the total volume of data). In some embodiments, data objects designated as inactive may be subject to enhanced security measures or protocols. For example, in some cases, a data object designated inactive may be subject to modified access protocols, which may require, for example, multi-factor authentication (MFA) to access the data object, or to have read and/or write privileges with respect to the data object. In some cases, a data object designated inactive may be designated as “read only,” thereby eliminating write access to these data objects. Designating inactive data objects as “read only” reduces the risk that these data objects will be encrypted in a ransomware attack. In other cases, a data object designated inactive may be subject to modified read and/or write permissions that are limited to only those users which have active authorization to use such data object, and have in fact accessed such data object within a recent specified period.

In some embodiments, this classification scheme is based on the insight that, after being generated and after an initial period of activity, data objects in a typical enterprise or similar computer environment may become dormant or inactive, or otherwise infrequently accessed or used. At the same time, such data objects may be subject to “permission drift,” where an increasing number of people are awarded or retain privileges with respect to the data object, where no actual business need exists for granting and maintaining such permissions. The existence of a very large pool of data objects with a wide permissioning base significantly increases the potential attack surface of the computer system.

Common cybersecurity tools have typically managed access control by focusing on identity management, that is, the identity of the individuals within the organization that are granted access to which file. However, identity-based access management requires an intricate and cumbersome process of identity, time, and geographic policy management. The complexity of managing identities and access rights is a well-documented challenge in the cybersecurity industry, and traditional systems often require extensive resources and constant oversight to maintain an accurate and secure access control framework.

Conversely, the present technique manages data object access on a time-based approach, built on the principle that access should be aligned with the needs and schedules of the data or resources in question. This means that permissions are dynamically modified day-to-day, based on a predicted need to use each data object, rather than based on the identity of the user. Thus, the present technique does not attempt to discern which user should be able to access any piece of data, but rather dynamically predicts, on an ongoing basis, whether the data object is actually likely to be accessed by any of its authorized users. This proactive approach allows the system to adjust permissions and access rights in real-time, without the need for manual intervention by system administrators.

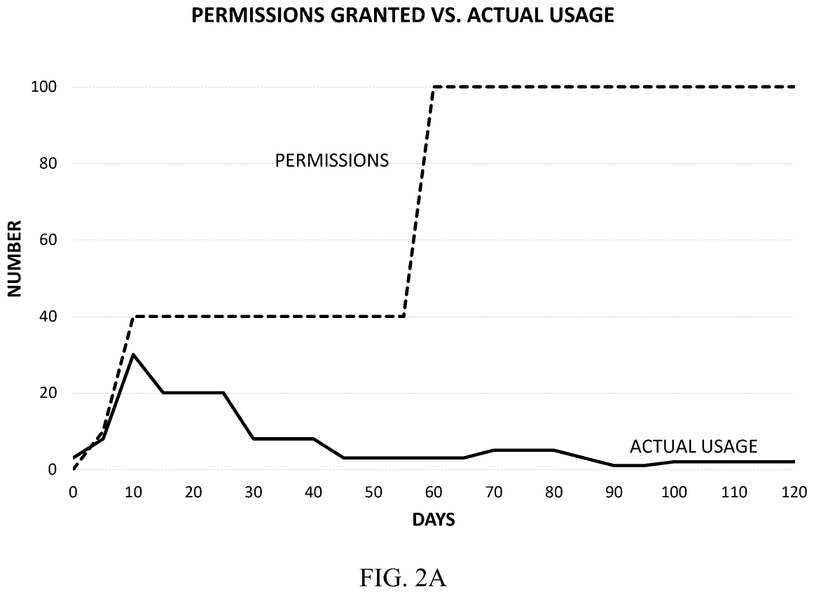

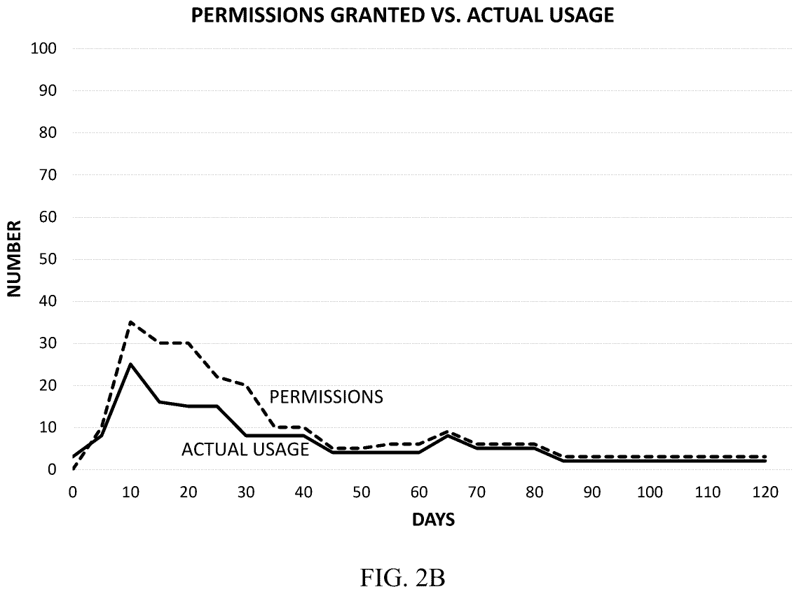

FIG. 2A depicts such an exemplary case of permission drift over the life of a data object, where the dashed line represents the number of access privileges granted over time with respect to a data object, and the solid line represents the number of actual instances of access to the data object over time.

An enterprise data object, e.g., a document, a file, or the like, may be crated on day one, by one or more initial users. In the next 2-3 days, the initial users may invite a handful of other users within the enterprise to review and comment on the created document. On day 10, the invited reviewers may in turn share the document with multiple other users, of which only a portion will actually access and/or edit the document. Over the first month, the document is gradually finalized, and the authorized users generally do not need to access or modify it any longer. However, the permissioning status quo is maintained and the permissions already granted typically are not withdrawn, despite there being no further business need to maintain them. Furthermore, on day 60, the document may be moved to another directory or location, for example, as part of system clean up. In the new location, the data object may inadvertently inherit the user-permissions structure associated with that new location. Suddenly, numerous additional users gain access to the document, even though it is no longer an actively-used document, and the likelihood that any of these users will need to access it is small. The large number of users with redundant privileges for this document represent an increased risk that the document may be impacted in case of a ransomware or similar attack. In the other hand, managing permissioning for the document now becomes a challenging and time-consuming process.

FIG. 2B depicts a similar case within an enterprise in which the present technique for active continuous mitigation of the exposure of a computer system or environment to malware attacks, by limiting and reducing the potential attack surface, is implemented. The dashed line represents the number of access privileges granted over time with respect to a data object, and the solid line represents the number of actual instances of access to the data object over time.

As can be seen, an enterprise data object, e.g., a document, a file, or the like, may be created on day one, by one or more initial users. In the next 2-3 days, these initial users may invite several other users within the enterprise to review and comment on the created document. On day 10, the invited reviewers may in turn share the document with multiple other users, of which only a portion actually access and/or modify the document.

During this period, a trained prediction model of the present technique may recurringly or periodically monitor the document, to predict the likelihood that each of the authorized users will access the document within the future predefined period of time (e.g., within the next 14 days). While the prediction model determines that at least one authorized user is likely to access the within the future predefined period of time, the document retains its “active” designation, and may be moved to a dedicate secure storage cache for active data objects. In such case, the data object will be subject to security and permissioning controls applied to the “active” class of data objects, and may remain available for access by its authorized users over the future predefined period of time, e.g., using the standard login or permission protocols in use by distributed computer system 100. In some embodiments, the prediction model may determine that one or more of the authorized users are unlikely to access the document within the future predefined period of time. The prediction model may then modify (e.g., to require MFA to access the document) or revoke the authorization of such users.

Over the first month, the document is gradually finalized, and the authorized users do not need to access or modify it any longer. The prediction model may recurringly or periodically monitor the relevant document (e.g., hourly, daily, etc.), to predict the likelihood that each of the authorized users will access the document within the future predefined period of time (e.g., the next 14 days). When the prediction model determines that none of the authorized users is likely to access the document within the future predefined period of time, the prediction model may classify the document as an “inactive” data object. In such case, the data object will be subject to security and permissioning controls applied to the “inactive,” which may require enhanced security and access controls. For example, in some cases, a data object designated inactive may be subject to modified access protocols, which may require multi-factor authentication (MFA) to access the data object, or to have read and/or write privileges with respect to the data object. As can be seen, this approach keeps the access permissions for the document in line with its actual predicted usage, and thus permission drift is prevented. The data object in question is removed from the pool of objects that represent the potential attack surface for the organization, thus reducing overall risk, without the need for intricate identity-based permissioning management.

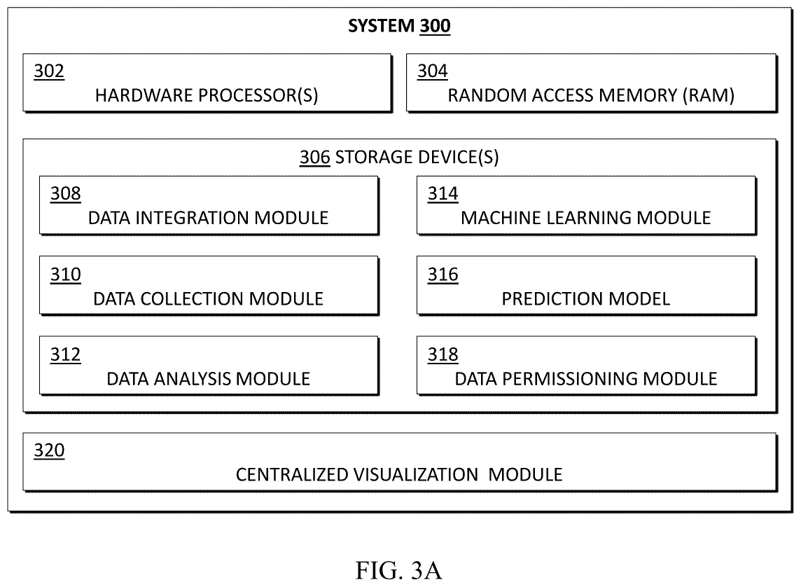

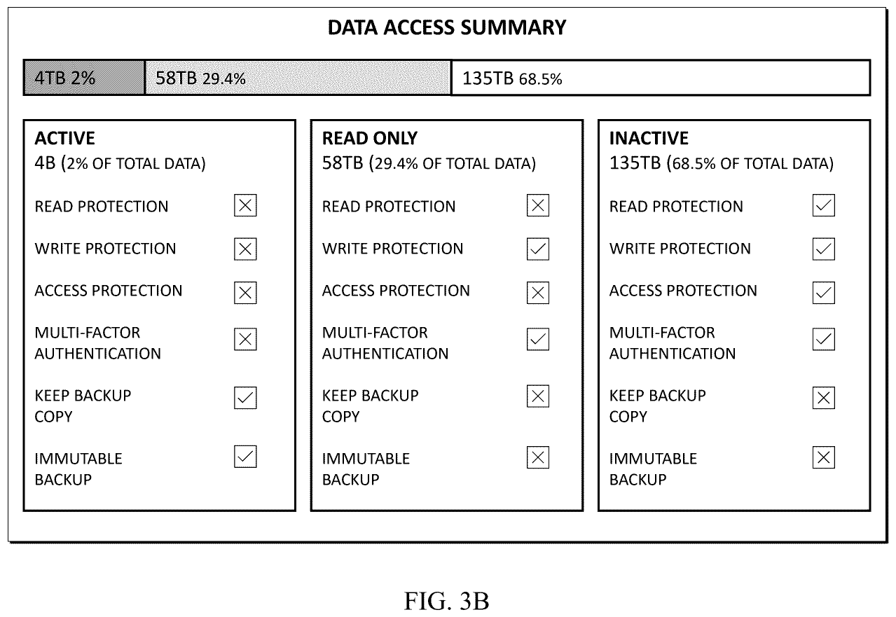

Reference is made to FIG. 3A, which is a block diagram of an exemplary system 300 for realizing the present technique for real-time dynamic centralized graphical visualization of a potential attack surface in a distributed computer system or environment.

In some embodiments, system 300 may comprise a processing module 302, and a random-access memory (RAM) 304, and/or one or more non-transitory computer-readable storage device 306.

Processing module 302 may include components such as, but not limited to, one or more central processing units (CPUs), graphics processing units (GPUs), or any other suitable multi-purpose or specific processors or controllers. Processing module 302 may be operationally directly and/or indirectly connected to, and control the operation of, storage device 306 and all other components of system 300.

Storage device 306 may be or may include, for example, one or more non-transitory computer-readable storage device(s), a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units.

In some embodiments, system 300 may store in storage device 306 software instructions or components configured to operate a processing unit (also ‘hardware processor,’ ‘CPU,’ or simply ‘processor’), such as processing module 302. The software instructions may be any executable code, e.g., a software application, a program, a process, task or script. In some embodiments, the software components may include an operating system, including various software components and/or drivers for controlling and managing general system tasks (e.g., memory management, storage device control, power management, etc.) and facilitating communication between various hardware and software components.

The software instructions and/or components operating processing module 302 may comprise may include one or more modules, such as a data integration module 308, a data collection module 310, a data analysis module 312, a machine learning module 314, a prediction model 316, and/or a permissioning module 318. These modules may be implemented in hardware only, software only, or a combination of both hardware and software.

In some embodiments, system 300 may further comprise a centralized graphical visualization module 320 configured to generate and display a centralized graphical visualization of the present technique.

In some embodiments, system 300 may further comprise a display monitor for displaying data and images, a control panel for controlling system 300, and/or a speaker for providing audio feedback.

In some embodiments, system 300 may comprise one or more software applications and/or hardware components that are native to a distributed computer system environment, such as computer system 100 shown in FIGS. 1A-1B, and may be operable to perform the steps of one or more methods of the present technique described herein with respect thereto. For example, system 300 may be realized as a client software application hosted on the target computer system and making use of its hardware and computational resources. However, in other cases, system 300 may be realized as an external standalone system which may operationally connect to a target computer system, such as computer system 100, via a public data network, to perform the steps of one or more methods of the present technique described herein with respect thereto.

System 300 as described herein is only an exemplary embodiment of the present invention, and in practice may be implemented in hardware only, software only, or a combination of both hardware and software. System 300 may have more or fewer components and modules than shown, may combine two or more of the components, or may have a different configuration or arrangement of the components. System 300 may include any additional component enabling it to function as an operable computer system, such as a motherboard, data busses, power supply, a network interface card, a display, an input device (e.g., keyboard, pointing device, touch-sensitive display), etc. (not shown). Components of system 300 may be co-located or distributed, or the system may be configured to run as one or more cloud computer ‘instances,’ ‘containers,’ ‘virtual machines,’ or other types of encapsulated software applications, as known in the art.

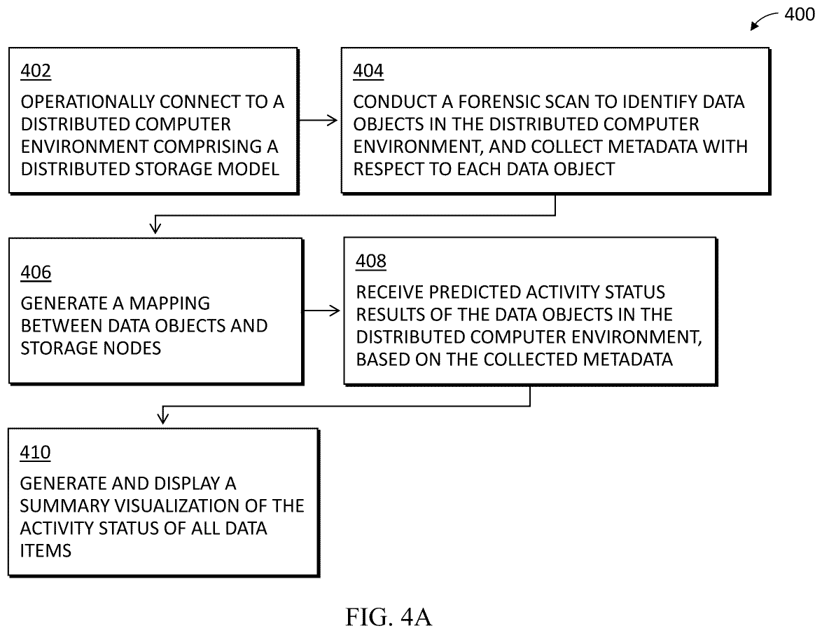

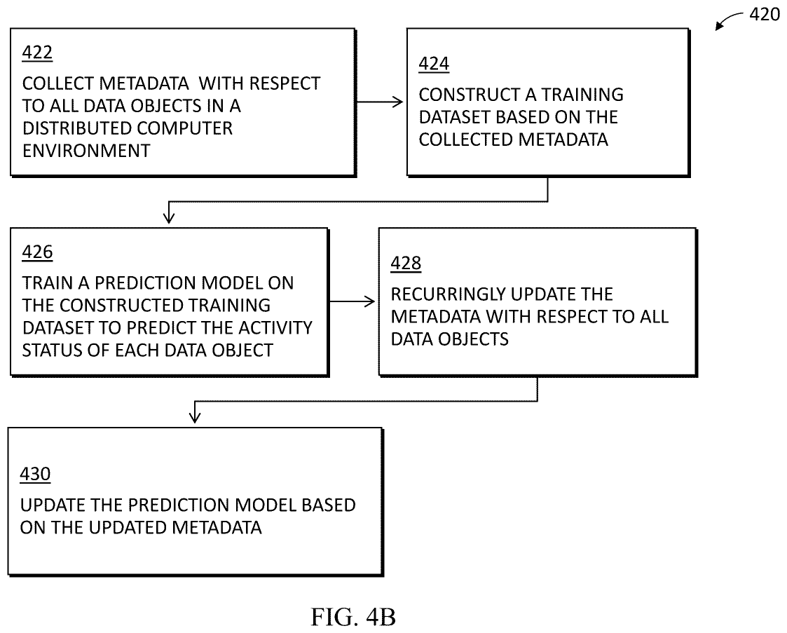

The instructions of system 300 will now be discussed with reference to the flowchart of FIG. 4A which illustrates the functional steps in a method 400 for generating and displaying a centralized graphical visualization of a potential attack surface in a distributed computer system or environment, based, at least in part, on categorizing each of the data objects within a distributed computer system, such as distributed computer system 100, according to its predicted activity status. In some embodiments, a predicted activity status indicates the likelihood that any such data object will be used and/or accessed by a user of the computer system or environment within a future predefined period of time In some embodiments, the dynamic centralized graphical visualization presents the output results of a trained prediction model of the present technique, configured to output a classification which indicates, with respect to each of the data objects in distributed computer system 100, the likelihood that such data object will be used and/or accessed by a user within a future predefined period of time, such as the next hour, day 7 days, 14 days, 30 days, or any other desired or suitable period of time.

In some embodiments, the data object summary panel is a dynamic dashboard component designed for monitoring and managing data objects (e.g., files, objects, or records) in distributed computer system 100. It focuses on the activity status of each data object, defined as the probabilistic likelihood that the item will be accessed or modified by a user within a future defined time period. The panel aims to help system administrators, data engineers, or analysts quickly identify high-activity data for optimization (e.g., caching or replication), low-activity data for archiving or cost-saving measures, and anomalies that might indicate issues like data hoarding or security risks. It uses interactive elements for drill-down analysis, with real-time updates via APIs polling the distributed system's metrics.

In some embodiments, the panel may be laid out in several sections such as a summary overview, a detailed item breakdown, and trend analysis. The summary overview may provide a high-level snapshot of the overall system based on data object. activity statuses. For example, the distribution of data objects across activity categories may be represented using a pie chart or similar graphic representation. The detailed breakdown section may list individual data objects by type or categories, sortable and filterable by activity status, to allow granular inspection. The panel may include buttons or checkboxes for applying quick operations, such as for applying various security measures and protection (such as read/write protection or MFA), caching, backup, and the like. A trend analysis section may visualize how activity statuses evolve over time, aiding in predictive maintenance. This section may use line or similar charts to plot activity likelihood trends for selected items or aggregates over time.

FIG. 3B depicts an exemplary data object summary panel providing centralized graphical visualization of all data objects discovered, located and classified within a target computer system, such as distributed computer system 100. The data object summary panel presents a dynamic centralized graphical visualization of all data objects within the distributed storage scheme of distributed computer system 100, according to their assigned category or class.

For example, the data object summary panel may present a visual summary of all data objects across all distributed storage nodes 122A-122N within distributed computer system 100, based on their predicted activity status. As can be seen in the example of FIG. 3B, the data object summary panel may provide visual and numerical indication of the total number or proportion of data objects within each of the classification categories. Thus, the data object summary panel visually presents the output results of a trained prediction model of the present technique, configured to output a classification which indicates, with respect to each of the data objects in distributed computer system 100, the likelihood that such data object will be used and/or accessed within a future predefined period of time, e.g., within the next hour, day, 7 days, 14 days, 30 days, or any other desired or suitable period of time.

In the exemplary data object summary panel shown in FIG. 3B, the prediction results present the allocation of all data objects within distributed computer system 100 among three categories or siloes:
Active Data Objects: Comprising approx. 2% of the total data objects in distributed storage 120 within distributed computer system 100 that are likely to be accessed on a read/write/modify basis by at least one of its authorized users within the future predefined period of time.
Read-Only Data Objects: Comprising approx. 29.4% of the total data objects in distributed computer system 100 that are likely to be accessed only on a read-only basis by any of its authorized users within the future predefined period of time.
Inactive data objects: Comprising approx. 68.5% of the total data objects in distributed storage 120 within distributed computer system 100, that are unlikely to be used or accessed by any of its authorized users within the future predefined period of time.

However, in other cases, the prediction results may include fewer, more, different, or alternative classes or categories.

In some embodiments, the data object summary panel may provide for centralized management and configuration of policies and controls with respect to each of the classes or categories of data objects. For example, in each category, the data object summary panel provides for links to various management and configuration tools, such as a security configurator, a vulnerability manager, a system configurator, a network device manager, and the like.

In some embodiments, the graphical visualization presents additional graphical metadata with respect to each category or silo. For example, the graphical visualization may include indications as to security, access, protection, encryption, and/or backup policies applied to each of the categories or siloes, including, but not limited to, read/write protection, access protection, MFA requirements, backup configuration, etc.

In one example, the data object summary panel provides for centrally applying backup controls and policies to each class represented in the panel. For example, as can be seen in FIG. 3B, an administrator can centrally apply mandatory backup to the “active class” only, while “inactive” and “read only” items are not subject to backup. Similarly, an administrator can centrally indicate that the mandatory backup is an immutable backup.

In some embodiments, the dynamic centralized graphical visualization presented in FIG. 3B may be customizable to suit the requirements of particular enterprises and/or users. For example, the graphical visualization presents additional metadata, etc.

The various steps of method 400 will be described with continuous reference to exemplary system 300 shown in FIG. 3A.

The various steps of method 400 may either be performed in the order they are presented or in a different order (or even in parallel), as long as the order allows for a necessary input to a certain step to be obtained from an output of an earlier step. In addition, the steps of method 400 may be performed automatically and/or recursively (e.g., by system 300 of FIG. 3A), unless specifically stated otherwise.

Method 400 begins in step 402, wherein system 300 executes data integration module 308 to operationally connect to a computer environment, typically a distributed or decentralized computer system having multiple interconnected systems and storage locations over one or more private or public platforms. An example of such a system is exemplary distributed computer system 100 depicted in FIG. 1A, comprising exemplary distributed storage 120 depicted in FIG. 1B.

In some embodiments, computer system 100 may be any private, enterprise, governmental agency, healthcare facility, or similar computer system or environment. In one example, computer system 100 may comprise any one or more of the following elements:
A network 102 which interconnects the various nodes of distributed computer system 100 and provides access to the stored data therein. Network 102 may comprise one or more interconnected private and public networks, including, but not limited to, a local area network (LAN), a virtual network, such as Microsoft Azure Virtual Network or similar, and/or the Internet.
An on-premise data center 104.
One or more endpoints 106, such as workstations, laptops, and mobile devices.
Enterprise file storage 108.
One or more public clouds 110.
A private cloud 112.
A blob storage 114.

However, in other cases, computer system 100 may comprise fewer, additional, and/or other different components and elements.

In some embodiments, distributed computer system 100 may comprise a distributed storage 120, which may be organized as a plurality of storage nodes 122A-122N accessible to users of distributed computer system 100 according to a configurable data access plan. Each storage node 122 may be configured to store a plurality of data objects. In some cases, distributed computer system 100 may store replicas of data objects within two or more storage nodes 122A-122N. However, each replica need not correspond to an exact copy of the data object, and thus each replica may be designated as a separate data object. In some embodiments, a data object may be divided into a number of portions according to an encoding scheme, such that the object data may be recreated from all or some of the generated portions, wherein the generated data object portions may be stored in one or more storage nodes 122A-122N.

In some embodiments, system 300 may execute integration module 308 to connect to data sources within computer system 100 using standard protocols, essentially functioning as a client. In some embodiments, system 300 may execute data integration module 308 to connect to sources within computer system 100 using a minimal set of privileges, typically with read-only access and/or with admin access level.

In some embodiments, system 300 may execute data integration module 308 to interface with one or more data sources within computer system 100, such as, but not limited to:
Windows/Linux operating systems.
Enterprise storage solutions from vendors such as Dell, NetApp, HP, Fujitsu, Pure and Vast.
Cloud storage platforms such as Google Drive, SharePoint (both online and on-premises), Box, Dropbox, and Amazon S3.
Common database platforms.
Common security tools.

With reference back to FIG. 4A, in step 404, system 300 may execute data collection module 310 to receive the results of a forensic scan of distributed computer system 100, to create an inventory and mapping of all data objects in distributed storage 120. In some embodiments, such forensic scan may be performed by executing data integration module 308 and/or data collection module 310 to scan distributed computer system 100, to identify and create an inventory of all data objects, including, but not limited to:
Files.
Directories.
Databases.
Storage devices.
Installed programs or applications.
Users.
Groups.
Endpoints and end-devices.
Servers.
Network nodes.
Public and private cloud storage containers.

However, additional and/or different types or categories of objects may be included in the inventory created by system 300.

In some embodiments, system 300 may execute data collection module 310 to collect and store metadata with respect to the each data object identified in the forensic scan performed in step 404, e.g., in a dedicated storage resource of system 300 and/or using existing on-premises or cloud-based storage resources of distributed computer system 100. In some embodiments, the collected metadata may include, with respect to each data object, some or all of the metadata categories and elements detailed with reference to step 422 of method 420 described hereinbelow, which is incorporated herein by reference.

For example, system 300 may integrate with existing storage resources of computer environment 100, such as NetApp storage platform, Windows File Servers, or other similar storage systems. In some embodiments, system 300 may execute data collection module 310 to receive the results of subsequent recurrent scans to update the logged or stored inventory of data objects with any additions and/or changes to data objects. Accordingly, system 300 may execute data collection module 310 to receive the results subsequent recurrent scans to update the logged or stored inventory of data objects with any (i) newly-created data objects, (ii) data objects that were deleted, and/or (iii) data objects that were modified or relocated within computer system 100. In some embodiments, such subsequent recurrent scans may be performed, for example, hourly, daily, weekly, bi-weekly, or according to any other shorter or longer desired interval.

In step 406, system 300 may execute data analysis module 312 to receive a mapping of all data objects within distributed computer system 100, which provides an indication with respect to the location of each data object within the various storage nodes 122A-122N of distributed storage 120. In some embodiments, such mapping may be generated by system 300 executing data analysis module 312 to generate and store a mapping of all data objects within distributed computer system 100, which indicates a mapping between each data object and one or more storage nodes 122A-122N in distributed storage 120.

In some embodiments, the generated mapping comprises, as applicable with respect to each data object, metadata with respect to one or more replicas of each data object, and/or metadata with respect to data objects with are divided into a number of portions according to an encoding scheme and stored over two or more different storage nodes 122A-122N. In some embodiments, the collected metadata may include, with respect to each data object, some or all of the metadata categories and elements detailed with reference to step 422 of method 420 described hereinbelow, which is incorporated herein by reference.

In step 408, system 300 may execute data analysis module 312 to receive prediction results which indicate a predicted activity status with respect to each of the data objects in distributed computer system 100, as identified in step 404 and mapped in step 406. In some embodiments, system 300 may execute data analysis module 312 to receive and associated and store with each data object in distributed computer system 100 as identified in step 404 and mapped in step 406, prediction results which indicate a predicted activity status with respect to the data object.

In some embodiments, predicted activity status with respect to each of the data objects in distributed computer system 100 indicates the likelihood that such data object will be used and/or accessed by a user within a future predefined period of time, such as the next hour, day 7 days, 14 days, 30 days, or any other desired or suitable period of time.

In some embodiments, the prediction results may be generated by executing machine learning module 314 to apply trained prediction model 316 to classify data objects within distributed computer system 100. In some embodiments, system 300 may execute machine learning module 314 to apply prediction model 316 on metadata collected with respect to data objects in distributed computer system 100 (for example, one or more of the metadata types and categories as described with reference to step 422 in method 420 hereinbelow, which is incorporated herein by reference).

In some embodiments, the inferencing of prediction model 316 to classify data objects within distributed computer system 100 obtains predictions with respect to the predicted activity status of each data object.

In some embodiments, the predictions indicate, with respect to each data object in computer system 100, the likelihood that such data object will be used and/or accessed within a future predefined period of time. In some embodiments, the future predefined period of time may be e.g., the next hour, day, 7 days, 14 days, 30 days, or any other desired or suitable period of time.

In one embodiment, the predictions are based on a binary classification (i.e., 0/1, or yes/no) which indicates, with respect to each data object in computer system 100, that the data object is (i) “active,” i.e., likely to be used and/or accessed within the future predefined period of time, or (ii) “inactive,” i.e., unlikely to be used and/or accessed within the future predefined period of time. In some embodiments, each classification result is associated with a probability score. For example, the binary classification may indicate, with respect to each data object in computer system 100, that the data object is (i) “active,” i.e., likely to be used and/or accessed within the future predefined period of time, when the probability score exceeds a specified threshold (e.g., 70%), or (ii) “inactive,” i.e., unlikely to be used and/or accessed within the future predefined period of time, when the probability score is below the specified threshold.

In another embodiment, the predictions are based on a multi-class classification, which assigns one of a set of three or more predetermined class labels to each data object, for example:
Class I: Data object is active and likely to be accessed on a read/write/modify basis within the future predefined period of time. This prediction may indicate globally, with respect to all authorized users of a data object, that the data object is active and is likely to be used and/or accessed within the future predefined period of time. Alternatively, this prediction may indicate separately, with respect to each authorized user of a data object, whether the data object is active and likely to be used and/or accessed by such authorized user within the future predefined period of time.
Class II: Data object is inactive and unlikely to be used or accessed within the future predefined period of time.
Class III: Data object is inactive, and is likely to only be accessed on a read-only basis within the future predefined period of time.
Class IV: Data object is inactive, and is likely to be accessed only for periodic system maintenance or similar purposes within the future predefined period of time.

In some embodiments, each such classification is associated with a probability score.

In step 410, system 300 may execute centralized graphical visualization module 320 to generate and display (e.g., on a display monitor) a centralized graphical visualization of the prediction results with respect to all data objects within an enterprise, such as distributed computer system 100.

Reference is made back to FIG. 3B which depicts an exemplary centralized graphical visualization of the prediction results obtained in step 410 with respect to all data objects within distributed computer system 100.

In some embodiments, the centralized graphical visualization presents the output results of a trained prediction model of the present technique, configured to output a classification which indicates a predicted activity status with respect to each of the data objects stored in storage nodes 122A-122N of distributed storage 120 within distributed computer system 100. In some embodiments, the predicted activity status indicates the likelihood that such data object will be used and/or accessed by a user within a future predefined period of time, such as the next hour, day 7 days, 14 days, 30 days, or any other desired or suitable period of time.

In some embodiments, the centralized graphical visualization is based, at least in part, on the mapping of all data objects within distributed computer system 100, generated in step 408.

In the exemplary centralized graphical visualization shown in FIG. 3B, the prediction results present the allocation of all data objects within distributed computer system 100 among three categories or siloes:
Active Data Objects: Comprising approx. 4% of the total data objects in storage nodes 122A-122N of distributed storage 120 within distributed computer system 100 that are likely to be accessed on a read/write basis by at least one of its users within the future predefined period of time.
Read-Only Data Objects: Comprising approx. 29.4% of the total data objects in storage nodes 122A-122N of distributed storage 120 within distributed computer system 100 that are likely to be accessed only on a read-only basis by any of its users within the future predefined period of time.
Inactive data objects: Comprising approx. 68.5% of the total data objects in storage nodes 122A-122N of distributed storage 120 within distributed computer system 100, that are unlikely to be used or accessed by any of its users within the future predefined period of time.

In some embodiments, the graphical visualization presents a centralized graphical visualization of all data objects within the distributed storage scheme 120 of distributed computer system 100. For example, the graphical visualization presents a centralized graphical visualization of the predicted activity status all data objects across all distributed storage nodes 122A-122N within distributed computer system 100.

In some embodiments, steps 408-410 of method 400 may be repeated by system 300 recurrently, e.g., based on an hourly, daily, weekly, bi-weekly, or according to any other shorter or longer desired. Each such recurrence updates the classification results which indicate a predicted activity status with respect to each of the data objects in distributed computer system 100, and, correspondingly, the centralized graphical visualization of the prediction results.

In some embodiments, the graphical visualization presents additional graphical metadata with respect to each category or silo. For example, the graphical visualization may include indications as to security, access, protection, encryption, and/or backup policies applied to each of the categories or siloes, including, but not limited to, read/write protection, access protection, MFA requirements, backup configuration, etc.

In some embodiments, the centralized graphical visualization presented in FIG. 3B may be customizable to suit the requirements of particular enterprises and/or users. For example, the graphical visualization presents additional metadata, etc.

Optionally, system 300 may execute permissioning module 318 to cache those data objects classified as active, i.e., approximately 2-4% of the total data objects. In some embodiments, the active data objects may be stored in a dedicated storage resource of system 300 and/or using existing on-premises or cloud-based storage resources of distributed computer system 100. In some embodiments, the cache is secure, scanned for malware, and virtually air-gapped from the rest of the data. The active data objects in the cache are updated and/or synchronized periodically with the primary data, and are scanned for encryption. If any data object is suspected as being encrypted, the cache automatically stores a previous version of the data object and potentially triggers a suitable system alert. In some embodiments, the active data objects in the cache are made available for access by their users in the computer environment over the future predefined period of time. In some embodiments, such data objects are made available for access by users in the computer environment, using the standard login or permission protocols in use by the computer environment.

In some embodiments, data objects classified as inactive, i.e., approximately 96-98% of the total data objects in distributed computer system 100, may be subject to enhanced security measures or protocols. For example, in some cases, a data object designated inactive may be subject to modified permissioning or access protocols, which may require, for example, multi-factor authentication (MFA) to access the data object, or to have read and/or write privileges with respect to the data object. In some cases, a data object designated inactive may be designated as “read only,” thereby eliminating write access to these data objects, which reduces the risk that these data objects will be encrypted in a ransomware attack. In other cases, a data a data object designated inactive may be subject to modified read and/or write permissions that are limited to only those users which have active authorization to use such data object, and have in fact accessed such data object within a recent specified period.

The instructions of system 300 will now be discussed with reference to the flowchart of FIG. 4B which illustrates the functional steps in a method 420 for training and inferencing a prediction model configured to classify data objects in a distributed computer environment according to their predicted activity status.

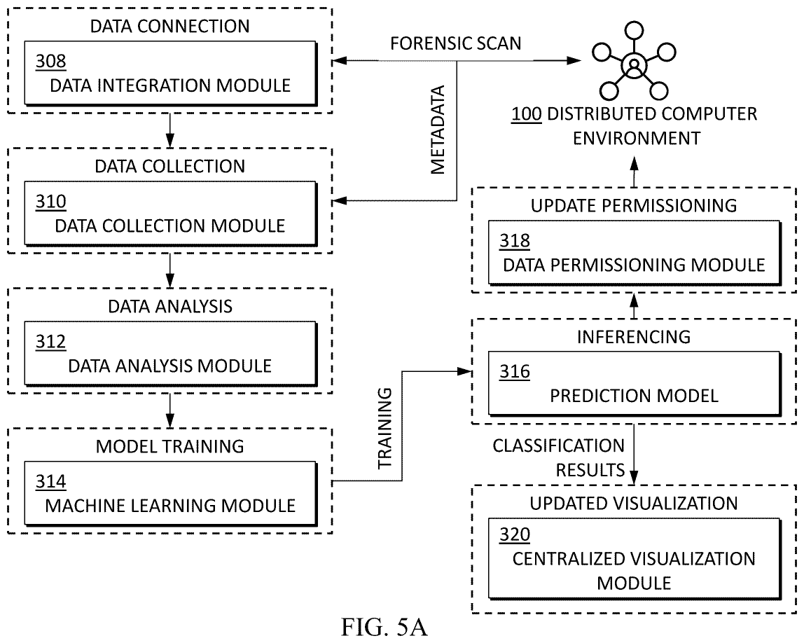

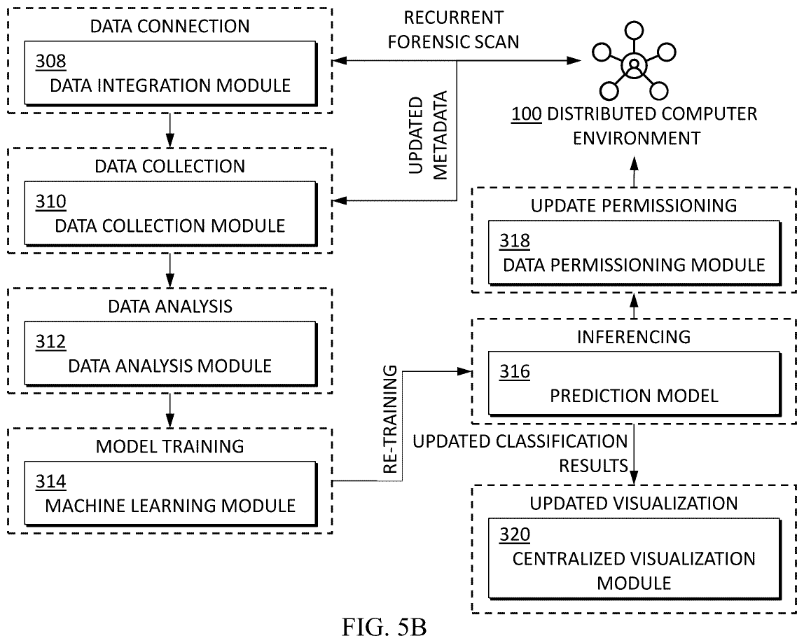

The various steps of method 420 will be described with continuous reference to exemplary system 300 shown in FIG. 3A, and to the block diagrams of FIGS. 5A-5B, which provide an overview of a pipeline for training, inferencing, and updating of a prediction model of the present technique.

The various steps of method 420 may either be performed in the order they are presented or in a different order (or even in parallel), as long as the order allows for a necessary input to a certain step to be obtained from an output of an earlier step. In addition, the steps of method 420 may be performed automatically (e.g., by system 300 of FIG. 3A), unless specifically stated otherwise.

Methods 420 begins in step 422, wherein system 300 may execute data integration module 308 to operationally connect to a computer environment, typically a distributed or decentralized computer system having multiple interconnected systems and storage locations over one or more private or public platforms. An example of such a system is exemplary distributed computer system 100 depicted in FIG. 1A, comprising exemplary distributed storage 120 depicted in FIG. 1B.

In some embodiments, computer system 100 may be any private, enterprise, governmental agency, healthcare facility, or similar computer system or environment. In one example, computer system 100 may comprise any one or more of the following elements:
A network 102 which interconnects the various nodes of distributed computer system 100 and provides access to the stored data therein. Network 102 may comprise one or more interconnected private and public networks, including, but not limited to, a local area network (LAN), a virtual network, such as Microsoft Azure Virtual Network or similar, and/or the Internet.
An on-premise data center 104.
One or more endpoints 106, such as workstations, laptops, and mobile devices.
Enterprise file storage 108.
One or more public clouds 110.
A private cloud 112.
A blob storage 114.

However, in other cases, computer system 100 may comprise fewer, additional, and/or other different components and elements.

In some embodiments, distributed computer system 100 may comprise a distributed storage 120, which may be organized as a plurality of storage nodes 122A-122N accessible to users of distributed computer system 100 according to a configurable data access plan. Each storage node 122 may be configured to store a plurality of data objects. In some cases, distributed computer system 100 may store replicas of data objects within two or more storage nodes 122A-122N. However, each replica need not correspond to an exact copy of the data object, and thus each replica may be designated as a separate data object. In some embodiments, a data object may be divided into a number of portions according to an encoding scheme, such that the object data may be recreated from all or some of the generated portions, wherein the generated data object portions may be stored in one or more storage nodes 122A-122N.

In some embodiments, system 300 may execute integration module 308 to connect to data sources within computer system 100 using standard protocols, essentially functioning as a client. In some embodiments, system 300 may execute data integration module 308 to connect to sources within computer system 100 using a minimal set of privileges, typically with read-only access and/or with admin access level.

In some embodiments, system 300 may execute data integration module 308 to interface with one or more data sources within computer system 100, such as, but not limited to:
Windows/Linux operating systems.
Enterprise storage solutions from vendors such as Dell, NetApp, HP, Fujitsu, Pure and Vast.
Cloud storage platforms such as Google Drive, SharePoint (both online and on-premises), Box, Dropbox, and Amazon S3.
Common database platforms.
Common security tools.

System 300 may then execute data collection module 310 to perform a forensic scan of computer system 100, to discover and create an inventory of all data objects in computer system 100. In some embodiments, system 300 may execute data collection module 310 to scan computer system 100, to identify and create an inventory of all data objects, including, but not limited to:
Files.
File directories.
User directories.
Databases.
Storage devices.
Software programs or applications.
Users.
Groups.
Endpoints and end-devices.
Servers.
Network nodes.
Public and private cloud storage containers.

However, additional and/or different types or categories of objects may be included in the inventory created by system 400.

In some embodiments, system 300 may execute data collection module 310 to log and/or store metadata with respect to the results of the inventory scan, e.g., in a dedicated storage resource of system 300 and/or using existing on-premises or cloud-based storage resources of computer system 100. For example, system 300 may integrate with existing storage resources of computer environment 100, such as NetApp storage platform, Windows File Servers, or other similar storage systems.

In some embodiments, system 300 may execute data collection module 310 to perform recurrent scans to update the logged or stored inventory of data objects with any additions and/or changes to data objects. Accordingly, system 300 may execute data collection module 310 to perform subsequent recurrent scans to update the logged or stored inventory of data objects with any (i) newly-created data objects, (ii) data objects that were deleted, and/or (iii) data objects that were modified or relocated within computer system 100. In some embodiments, such subsequent recurrent scans may be performed, for example, hourly, daily, weekly, bi-weekly, or according to any other shorter or longer desired interval.

System 300 may then execute data collection module 310 to collect detailed metadata with respect to each of the data objects identified in computer system 100.

In some embodiments, system 300 may execute data collection module 310 to collect the following categories of metadata:
Temporal features: Including time since last access, time since last modification, age of the data item, and the like.
Frequency features: Number of accesses in the past defined period, average access frequency over a rolling window, burstiness score (e.g., variance in access intervals to detect sporadic vs. regular use).
Contextual features: Data type (e.g., image, document, code file—encoded as categorical variables), size of the data item.
User-specific patterns: Number of unique users who have accessed it, or user role/group.
System-wide signals: Overall system load or seasonal trends, like higher access during business hours.
Derived features: Recency-weighted frequency (e.g., using exponential decay to prioritize recent accesses).
Embeddings from metadata: File names or paths processed via NLP to infer content relevance.

In some embodiments, system 300 may execute data collection module 310 to collect the following metadata with respect to each data object as may be applicable, including, but not limited to:
Data object name (such as a file name). In some cases, the name may be encoded (e.g., using natural language processing methods, NLP), to convert any meaningful textual data object name into a representation which preserves the meaning of the name (while potentially also providing anonymization).
Data object tags (e.g., user-supplied tags).
Data object type (e.g., (e.g., format or application type).
Data object creation date.
Data object size.
Data object location within the network/path (e.g., a current, past or future location of the data object and network pathways to/from the data object).
Data object owner and/or author (e.g., the client or user that generates the data object), including, but not limited to:
   Data object owner and/or author historical access and usage history with respect to other data objects, over a predefined period of time (e.g., most recent hour, day, 7 days, 14 days, 30 days, life of data object, etc.).
   Data object owner and/or author historical access and usage history with respect to other data objects having similar names, over a predefined period of time (e.g., most recent hour, day, 7 days, 14 days, 30 days, life of data object, etc.).
Data object main contributors, identifying users who have made changes to the data object.
Data object content (e.g., an indication as to the existence of a particular search term).
Storage type (e.g., on-premise, private cloud, public cloud, etc.).
Geographic storage location.
Business unit (e.g., a group or department that generates, manages or is otherwise associated with the data object).
Data object historical access and usage:
   Times of data object access instances (including, e.g., day of week, day of month, week of year, time of day, etc.), during a predefined period of time (e.g., most recent hour, day, 7 days, 14 days, 30 days, life of data object, etc.).
   Count, frequency and recency of data object access during the predefined period of time.
   Identity of accessing user(s).
   Types of access (e.g., read/write/modify).
   Statistics aggregating any historical access and usage data into statistics such as sum totals, counts, averages, etc.
Other data objects associated with the data objects:
   Other data objects sharing the same or a similar name. In some cases, name similarity may be determined based on natural language processing (NLP) techniques. In other examples, data object names may be converted into a numerical representation (e.g., using textual embedding), which preserves the meaning of the name. Name similarly may be determined based on a distance between NLP or numerical representations, such as Euclidian distance or any other suitable measure.
   Historical access and usage of other data objects sharing the same or a similar name.
   Other data objects created within a specified time period of the data object (e.g., within one hour, day, 7 days, 14 days, month, or any other suitable time period before or after the creation of the data object).
   Other data objects created within a specified time period of the data object (e.g., within one hour, day, 7 days, 14 days, month, or any other suitable time period before or after the creation of the data object) by the same owner and/or author.
   Calendar appointments associated with the data object (for example, calendar appointments in which the data object is mentioned, linked to, or to which it is attached).
   Email communications associated with the data object (for example, email communication in which the data object is mentioned, linked to, or to which it is attached).
Scheduled maintenance associated with the data object.
Data object and system metadata:
   Boot sectors.
   Partition layouts.
   File location within a file folder directory structure.
   User permissions.
   Owners.
   Groups.
   Access control lists (ACLs).
   Registry Information.

The metadata may be collected with respect each data object over a predefined period of time, e.g., most recent hour, day, 7 days, 14 days, 30 days, or any other suitable period of time. In one example, the metadata may be collected for the life of each data object. In some cases, certain of the metadata may be aggregated into statistics, such as sum totals, counts, averages, etc.

In some embodiments, system 300 may execute data collection module 310 to store the collected metadata, e.g., in a dedicated storage resource of system 300 and/or using existing on-premises or cloud-based storage resources of computer system 100.

In some embodiments, after the initial metadata collection stage, system 300 may execute data collection module 310 to perform subsequent recurrent periodic metadata collection scans, to update the logged or stored collected metadata with any additions and/or changes. For example, system 300 may execute data collection module 310 to perform subsequent recurrent periodic metadata collection scans with respect to any newly-created data objects, and/or with respect to any data objects that were changed or modified since the most recent metadata collection scan.

In some embodiments, such subsequent periodic scans may be performed, for example, hourly, daily, weekly, bi-weekly, or according to any other shorter or longer desired interval.

System 300 may additionally execute data analysis module 312 to generate and store a mapping of all data objects within distributed computer system 100, which provides an indication with respect to the location of each data object within the various storage nodes 122A-122N of distributed storage 120. In some embodiments, the generated mapping comprises, as applicable with respect to each data object, metadata with respect to one or more replicas of each data object, and/or metadata with respect to data objects with are divided into a number of portions according to an encoding scheme and stored over two or more different storage nodes 122A-122N.

With reference back to FIG. 4B, in step 424, system 300 may execute data analysis module 312 to construct a training dataset from the metadata collected in step 408 with respect to the data objects in computer system 100.

In some embodiments, the constructed training dataset may comprise, for each data object, a set of features representing the data object and its respective data points, metadata and statistics as collected in step 422.

In some examples, a training dataset may comprise, for each data object, a set of features representing the data object and its respective data points, metadata and statistics, and data object over a defined period of time, as collected in step 422. In some embodiments, each set of features with respect to a data object may be labeled with a ground-truth label indicating whether the data object was subsequently used and/or accessed within a future predefined period of time, e.g., within the next hour, day, 7 days, 14 days, 30 days, or any other desired or suitable period of time. In some examples, a training dataset may comprise for each data object, a set of features representing the respective data points, metadata and statistics over a predefined period of time, as collected in step 422. In some embodiments, each such set of features may be labeled with a ground-truth label indicating whether the data object was subsequently used and/or accessed within a future predefined period of time, e.g., within the next hour, day, 7 days, 14 days, 30 days, or any other desired or suitable period of time.

With reference back to FIG. 4B, in step 426, system 300 may execute machine learning module 314 to train a machine learning model on the training dataset constructed in step 424, to obtain a trained prediction model, which may be realized in prediction model 316.

In some embodiments, the machine learning model may comprise any one or more suitable machine learning algorithms, including, but not limited to, a combination of one or more classification algorithms, such as e.g., Random Forest, Gradient Boosting Classifier (e.g., XGBoost or LightGBM), Logistic Regression, Random Forest, or the like. In one example, the model can be trained to handle imbalanced classes (since inactive items are often more common) using techniques like class weighting or oversampling.

In some embodiments, prediction model 316 may be trained to output a classification which indicates, with respect to each data object in computer system 100, the likelihood that such data object will be used and/or accessed within a future predefined period of time. In some embodiments, the future predefined period of time may be e.g., the next hour, day, 7 days, 14 days, 30 days, or any other desired or suitable period of time.

In one embodiment, prediction model 316 is trained to output a binary classification (i.e., 0/1, or yes/no) which indicates, with respect to each data object in computer system 100, that the data object is (i) “active,” i.e., likely to be used and/or accessed within the future predefined period of time, or (ii) “inactive,” i.e., unlikely to be used and/or accessed within the future predefined period of time. In some embodiments, each classification result is associated with a probability score.

In some embodiments, prediction model 316 is trained to output a binary classification (i.e., 0/1, or yes/no) which indicates, with respect to each data object in computer system 100, that the data object is (i) “active,” i.e., likely to be used and/or accessed within the future predefined period of time, when the probability score exceeds a specified threshold (e.g., 70%), or (ii) “inactive,” i.e., unlikely to be used and/or accessed within the future predefined period of time, when the probability score is below the specified threshold.

In one variation of this embodiment, prediction model 316 may be trained to output a classification which indicates globally, with respect to all authorized users of a data object, that the data object is active and is likely to be used and/or accessed within the future predefined period of time. In another variation of this embodiment, prediction model 316 may be trained to output classification which indicates separately, with respect to each authorized user of a data object, whether the data object is active and likely to be used and/or accessed by such authorized user within the future predefined period of time.

In another embodiment, prediction model 316 is trained to output a multi-class classification, which assigns one of a set of three or more predetermined class labels to each data object, for example:
Class I: Data object is active and likely to be accessed on a read/write/modify basis within the future predefined period of time. This prediction may indicate globally, with respect to all authorized users of a data object, that the data object is active and is likely to be used and/or accessed within the future predefined period of time. Alternatively, this prediction may indicate separately, with respect to each authorized user of a data object, whether the data object is active and likely to be used and/or accessed by such authorized user within the future predefined period of time.
Class II: Data object is inactive and unlikely to be used or accessed within the future predefined period of time.
Class III: Data object is inactive, and is likely to only be accessed on a read-only basis within the future predefined period of time.
Class IV: Data object is inactive, and is likely to be accessed only for periodic system maintenance or similar purposes within the future predefined period of time.

In some embodiments, each such classification is associated with a probability score.

In some embodiments, In a typical enterprise computer system or environment, prediction model 316 is expected to classify between 2-4% of the total data objects in computer system 100 as “active,” i.e., data objects which are likely to be used and/or accessed on a read/write/modify basis within the future predefined period of time. In some embodiments, data objects classified as active, i.e., likely to be used and/or accessed on a read/write/modify basis within the future predefined period of time, may be stored in a dedicate storage cache, that is secure, scanned for malware, and virtually air-gapped from the rest of the data. In some embodiments, the active data objects are made available for access over the future predefined period of time using the standard login or permission protocols in use by the computer environment.

In some embodiments, prediction model 316 is expected to classify the balance of the data objects in computer system 100 (between 96-98% of the total) as “inactive,” i.e., as data objects which are unlikely to be used and/or accessed on a read/write/modify basis within the future predefined period of time. In some embodiments, data objects classified as inactive and unlikely to be used and/or accessed on a read/write/modify basis within the future predefined period of time may be subject to enhanced security measures or protocols. For example, in some cases, a data object designated inactive may be subject to modified access protocols, which may require, for example, multi-factor authentication (MFA) to access the data object, or to have read and/or write privileges with respect to the data object. In some cases, a data object designated inactive may be designated as “read only,” thereby eliminating write access to these data objects. Designating inactive data objects as “read only” reduces the risk that these data objects will be encrypted in a ransomware attack. In other cases, a data object designated inactive may be subject to modified read and/or write permissions that are limited to only those users which have active authorization to use such data object, and have in fact accessed such data object within a recent specified period.

In the case that prediction model 316 is trained to output a binary classification (i.e., 0/1, or yes/no), the balance of the data objects (between 96-98% of the total) will be classified as “inactive,” i.e., as data objects which are unlikely to be used and/or accessed on a read/write/modify basis within the future predefined period of time.

In the case that prediction model 316 is trained to output a multi-class classification as per the example given immediately above, the balance of the data objects in computer system 100, i.e., between 96-98% of the total, will be classified as one of, as the case may be: data object unlikely to be used or accessed within the future predefined period of time; data object likely to be accessed only on a read-only basis within the future predefined period of time; and/or data object likely to be accessed only for periodic system maintenance or similar purposes within the future predefined period of time.

With reference back to FIG. 4B, in step 428, system 300 may execute data collection module 310 to periodically or recurringly repeat step 422 of method 420 to (i) scan distributed computer system 100 to create an updated inventory of all data objects in distributed storage 120, (ii) generate an updated mapping of all data objects within distributed computer system 100, and (iii) collect updated detailed metadata with respect to the data objects in distributed computer system 100.

In step 430, system 300 may execute data analysis module 312 to periodically update the training dataset constructed in step 424, based on the updated metadata collected in step 428. System 300 may then execute machine learning module 314 to periodically or recurringly re-train prediction model 316 on the updated training dataset, to obtain a re-trained prediction model 316.

In some embodiments, steps 428-430 of method 420 may be repeated periodically or recurrently by system 300, e.g., based on an hourly, daily, weekly, biweekly, or according to any other shorter or longer desired.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computer/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computer/processing device receives computer readable program instructions from the network and forwards the computer readable program instructions for storage in a computer readable storage medium within the respective computer/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, a field-programmable gate array (FPGA), or a programmable logic array (PLA) may execute the computer readable program instructions by utilizing state information of the computer readable program instructions to personalize the electronic circuitry, in order to perform aspects of the present invention. In some embodiments, electronic circuitry including, for example, an application-specific integrated circuit (ASIC), may be incorporate the computer readable program instructions already at time of fabrication, such that the ASIC is configured to execute these instructions without programming.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range-10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

What is claimed is:

1. A computer-implemented method, comprising:
operationally connecting to a distributed computer system comprising a distributed storage, by interfacing with one or more data sources within said computer system;
obtaining an inventory of all data objects in the distributed computer system;
collecting metadata regarding each of said data objects;
based on said metadata, generating, with respect to each of said data objects, a prediction which indicate a likelihood that said data object will be accessed by a user within a future predefined period of time; and
generating and displaying a centralized graphical visualization of said predictions with respect to all of said data objects in said distributed computer system.

2. The computer-implemented method of claim 1, wherein said predictions are generated by applying a trained prediction model to said metadata regarding each of said identified data objects, to obtain said predictions.

3. The computer-implemented method of claim 2, wherein said prediction model is trained on a training dataset comprising a plurality of feature sets, each representing said metadata collected over a defined period of time regarding a respective one of said data objects, wherein each of said feature sets is labeled with a label indicating user access instances with respect to said respective data object which occurred subsequently to said defined period of time.

4. The computer-implemented method of claim 1, wherein said prediction assigns to each of the data objects one the following class labels (i) active, indicating that said data object is likely to be accessed by a user within said future predefined period of time, or (ii) inactive, indicating that said data object is unlikely to be accessed by a user within said future predefined period of time.

5. The computer-implemented method of claim 4, wherein each of said class labels is associated with a probability score.

6. The computer-implemented method of claim 1, wherein said metadata comprises, with respect to each of said data objects, historical access and usage data comprising one or more of the following: times of access instances; count, frequency and recency of access instances; identity of accessing users; and types of access instances.

7. The computer-implemented method of claim 6, wherein said metadata further includes, with respect to each respective said data object, said historical access and usage data with respect to other said data objects sharing the same or a similar name to said respective data object.

8. A system comprising:
at least one processor; and
a non-transitory computer-readable storage medium having stored thereon program instructions, the program instructions executable by the at least one processor to:
operationally connect to a distributed computer system comprising a distributed storage, by interfacing with one or more data sources within said computer system,
obtain an inventory of all data objects in the distributed computer system,
collect metadata regarding each of said data objects,
based on said metadata, generate, with respect to each of said data objects, a prediction which indicate a likelihood that said data object will be accessed by a user within a future predefined period of time, and
generate and display a centralized graphical visualization of said predictions with respect to all of said data objects in said distributed computer system.

9. The system of claim 8, wherein said predictions are generated by applying a trained prediction model to said metadata regarding each of said identified data objects, to obtain said predictions.

10. The system of claim 9, wherein said prediction model is trained on a training dataset comprising a plurality of feature sets, each representing said metadata collected over a defined period of time regarding a respective one of said data objects, wherein each of said feature sets is labeled with a label indicating user access instances with respect to said respective data object which occurred subsequently to said defined period of time.

11. The system of claim 8, wherein said prediction assigns to each of the data objects one the following class labels (i) active, indicating that said data object is likely to be accessed by a user within said future predefined period of time, or (ii) inactive, indicating that said data object is unlikely to be accessed by a user within said future predefined period of time.

12. The system of claim 11, wherein each of said class labels is associated with a probability score.

13. The system of claim 1, wherein said metadata comprises, with respect to each of said data objects, historical access and usage data comprising one or more of the following:
times of access instances; count, frequency and recency of access instances; identity of accessing users; and types of access instances.

14. The system of claim 13, wherein said metadata further includes, with respect to each respective said data object, said historical access and usage data with respect to other said data objects sharing the same or a similar name to said respective data object.

15. A computer program product comprising a non-transitory computer-readable storage medium having program instructions embodied therewith, the program instructions executable by a computer system to:
operationally connect to a distributed computer system comprising a distributed storage, by interfacing with one or more data sources within said computer system;
obtain an inventory of all data objects in the distributed computer system;
collect metadata regarding each of said data objects;
based on said metadata, generate, with respect to each of said data objects, a prediction which indicate a likelihood that said data object will be accessed by a user within a future predefined period of time; and
generate and display a centralized graphical visualization of said predictions with respect to all of said data objects in said distributed computer system.

16. The computer program product of claim 15, wherein said predictions are generated by applying a trained prediction model to said metadata regarding each of said identified data objects, to obtain said predictions.

17. The computer program product of claim 16, wherein said prediction model is trained on a training dataset comprising a plurality of feature sets, each representing said metadata collected over a defined period of time regarding a respective one of said data objects, wherein each of said feature sets is labeled with a label indicating user access instances with respect to said respective data object which occurred subsequently to said defined period of time.

18. The computer program product of claim 15, wherein said prediction assigns to each of the data objects one the following class labels (i) active, indicating that said data object is likely to be accessed by a user within said future predefined period of time, or (ii) inactive, indicating that said data object is unlikely to be accessed by a user within said future predefined period of time.

19. The computer program product of claim 18, wherein each of said class labels is associated with a probability score.

20. The computer program product of claim 15, wherein said metadata comprises, with respect to each of said data objects, historical access and usage data comprising one or more of the following: times of access instances; count, frequency and recency of access instances; identity of accessing users; and types of access instances.
